(19) United States
(12) Patent Application Publication
(10) Pub. No.: US 2006/0153008 A1
(43) Pub. Date: Jul. 13, 2006

(54) Control device and control method capable of external synchronization

(76) Inventors: Toshiyuki Miyamatsu, Fukuoka (JP); Mitsunori Kuzushima, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/545,271

(22) PCT Filed: Feb. 6, 2004
(86) PCT No.: PCT/JP04/01280

§ 371 Date: Feb. 10, 2006

(30) Foreign Application Priority Data
Feb. 12, 2003 (JP) 2003-33596
Mar. 11, 2003 (JP) 2003-65436

(51) Int. Cl. G04C 11/02

(52) U.S. Cl. 368/47

(57) ABSTRACT

The problem to be met by the present invention is to provide a controller which can execute control processing in synchronism with a synchronizing signal output from a host controller without taking into consideration a difference between a clock signal used for generating a synchronizing signal of the host controller and a clock signal used for generating a control cycle signal of a controller; and can enhance accuracy performance of control. According to the present invention, in a controller having a control interrupt processing section, a synchronization interrupt processing section adjusts means for generating a control cycle signal to thus generate a control interrupt signal such that the control cycle signal is generated while being delayed by an amount equal to or greater than the duration of an accuracy error between a quartz oscillator used for generating a synchronization interrupt signal and a quartz oscillator used for generating the control cycle signal, thereby executing control interrupt processing in synchronism with the synchronizing signal from the outside.

### FIELD OF THE INVENTION

The present invention relates to a controller having the function of performing control processing in synchronism with a synchronizing signal input from the outside such as a high-level controller, as well as to a method for controlling the controller

### BACKGROUND TECHNIQUE

A conventional controller will be described by reference to the drawings.

FIG. 8 is a block diagram showing the configuration of a conventional controller, and FIG. 9 is a timing chart for describing operation of the controller.

In FIG. 8, reference numeral 1 designates a host controller, and the apparatus has the function of outputting a synchronizing signal to the outside, the function of outputting data to the outside, and the function of receiving an input of data from the outside. Reference numeral 10 designates a quartz oscillator, which generates a clock signal. Reference numeral 11 designates a synchronizing signal generation circuit, which periodically generates a signal on the basis of a clock signal output from the quartz oscillator 10 and outputs the thus-generated signal to the outside. Reference numeral 12 designates an input/output circuit, which outputs data to the controller and receives data from the controller. Reference numeral S10 designates a synchronizing signal, which is periodically generated by the synchronizing signal generation circuit 11. Reference numeral S11 designates input/output data, which are exchanged with the controller by way of the input/output circuit 12.

Reference numeral 2 designates a controller, which is formed from a CPU, an interrupt circuit, an input/output circuit, and a control cycle generation circuit with synchronous function. Reference numeral 20 designates a CPU which operates in response to a clock signal output from the quartz oscillator. Upon receipt of a synchronization interrupt signal from the interrupt circuit, the controller causes a synchronization interrupt processing section to operate. Upon receipt of a control interrupt signal from the interrupt circuit, the controller causes a control interrupt processing section to operate. Reference numeral 21 designates an interrupt circuit. Upon receipt of a synchronizing signal S10 from the host controller, the controller generates a synchronization interrupt signal and outputs the thus-generated synchronization interrupt signal to the CPU 20. Moreover, when a signal is output from the control cycle generation circuit with synchronous function, the interrupt circuit generates a control interrupt signal and outputs the thus-generated signal to the CPU 20. Reference numeral 22 designates a quartz oscillator, which generates a clock signal. Reference numeral 23 designates an input/output circuit, which outputs data to the host controller and receives an input of data from the host controller. Reference numeral 24 designates a synchronization interrupt processing section, which processes input/output data S11. Reference numeral 25 designates a control interrupt processing section, which performs processing, such as position control, speed control, and torque control. Reference numeral 27 designates a control cycle generation circuit with synchronous function, which generates a signal during a given cycle on the basis of a clock signal output from the quartz oscillator 22 at a point in time at which an input of synchronizing signal S10 is received from the host controller, and outputs the thus-generated signal. Specifically, upon receipt of the synchronizing signal S10 generated during a given cycle by the host controller, the control cycle generation circuit with synchronous function outputs a control cycle signal, and concurrently commences measurement of the clock signal output from the quartz oscillator 22, outputs a control cycle signal when a count has reached a preset cycle, and initiates measurement of the clock signal output from the quartz oscillator 22. Through repetition of these operations, the control cycle generation circuit with synchronous function generates a signal during a given cycle. Reference numeral S20 designates a synchronization interrupt signal, which is generated by the interrupt circuit 21 when the synchronization signal S10 output from the host controller is input. Reference numeral S21 designates a control interrupt signal, which is generated by the interrupt circuit 21 when the control cycle signal output from the control cycle generation circuit 27 with synchronous function is input. Reference numeral S22 designates a control cycle signal, which is generated by the control cycle generation circuit with synchronous function 27.

In FIG. 9, upon receipt of an input of the synchronization signal S10 generated during a given cycle by the host controller, the interrupt circuit 21 generates a synchronization interrupt signal, and the CPU 20 causes the synchronization interrupt processing section to operate. Moreover, the control cycle generation circuit with synchronous function is activated, and the interrupt circuit 21 generates a control interrupt signal by means of the control cycle signal S22, and the CPU 20 causes the control interrupt processing section to operate. In this example, the synchronizing signal S10, which is output from the host controller, and the synchronization interrupt signal S20 are generated at intervals of 400 μs, and the control interrupt signal S21 is generated at intervals of 100 μs. Specifically, synchronization interrupt processing is performed at intervals of 400 μs, which is the cycle of the synchronizing signal. Control interrupt processing is performed a total of four times during a period of 400 μs by means of the control interrupt signal having a cycle of 100 μs. The accuracy of the quartz oscillator commonly used for a clock signal is of the order of 100 ppm or thereabouts. Hence, an error between the quartz oscillator 10 used in the host controller 1 and the quartz oscillator 22 used in the controller 2 is a maximum of 200 ppm. Therefore, the error assumes a value of 1/5000. During a period of 400 μs, the error assumes a value of 400 μs±0.08 μs. When the clock signal used for generating the synchronizing signal in the host controller is faster than the clock signal used for generating the control cycle signal of the controller, a control cycle signal of 100 μs is generated only four times during a period of 400 μs. The control cycle signal is not generated any further, and hence the control interrupt processing is normally executed a total of four times. In contrast, when the clock signal used for generating the synchronizing signal of the host controller is slower than the clock signal used for generating the control cycle signal of the controller, processing is performed as indicated by time D. Before the synchronizing signal is input from the host controller, the fifth control cycle signal is generated. Control interrupt processing to be originally executed four times is executed five times during a period of 400 μs.

When the synchronizing signal S10 generated by the host controller during a given cycle is input, a synchronization interrupt signal and a control interrupt signal are generated. In general, synchronization interrupt processing is higher than the control interrupt processing in terms of an interrupt priority level. Hence, the synchronization interrupt processing is executed first, and the control interrupt processing waits until completion of the synchronization interrupt processing. In this example, the time required to execute the synchronization interrupt processing is presumed to assume a value of 20 μs.

The interval between times at which control interrupt processing starts up originally corresponds to 100 μs which is a control cycle. However, as in the case of time C, the interval between a time at which first control interrupt processing during which the synchronizing signal S10 generated during a given cycle by the host controller is input and the second control interrupt processing, assumes a value of 80 μs which is determined by subtracting a period of 20 μs—during which synchronization interrupt processing is executed—from a control cycle of 100 μs.

From the interval between the time at which the fourth control interrupt processing is performed and the time at which the first control interrupt processing,—during which the next synchronizing signal S10 is input,—a value of 120 μs is assumed because processing waits until the synchronization interrupt processing being completed. Therefore, despite of the interval between times at which the second to fourth control interrupt processing operations are started up assumed a value of 100 μs, the interval between the times at which the first and second control interrupt processing operations are started up assumes a value of 80 μs, and from the interval between the time at which the fourth control interrupt processing starts and the time at which the next first control interrupt processing operation starts, a value of 120 μs is assumed. Hence, the control processing cycle at which the control interrupt processing is performed changes, and control accuracy is generally deteriorated.

The maximum process time allowed for control interrupt processing is originally a control period of 100 μs. As in time C, in the case of first control interrupt processing during which the synchronizing signal S10 generated during a given cycle by the host controller has been input, a period of 80 μs—which is determined by subtracting, from a control cycle of 100 μs, a period of 20 μs during which synchronization interrupt processing is performed—becomes an allowable maximum process time. Accordingly, despite the maximum process time allowed for the second to fourth control interrupt processing operations being 100 μs, the maximum process time allowed for the first control interrupt processing is 80 μs, and hence processing must be reduced to a size at which processing is completed within a maximum process time of 80 μs allowed for the first control interrupt processing.

As mentioned above, the conventional controller is arranged such that the clock signal used for generating the synchronizing signal of the host controller becomes faster than the clock signal used for generating the control cycle signal of the controller, in consideration of a difference between the clock signal used for generating the synchronizing signal of the host controller and the clock signal used for generating the control cycle signal of the controller; and such that the control interrupt processing section completes processing within a period of time determined by subtracting the process time required for synchronization interrupt processing from the control processing cycle (see, e.g., JP-A-11-259105 cited as Patent Document 1).

Moreover, in addition to Patent Document 1, for instance, JP-A-2002-333905 cited as Patent Document 2 describes a programmable controller capable of exchanging data between a controller and controlled equipment without fail.

However, the conventional controller must take into consideration realization of a combination of a controller with a host controller such that the clock signal used for generating the synchronizing signal of the host controller becomes faster than the clock signal used for generating the control cycle signal of the controller. Replacement operation required in the event of occurrence of a failure is troublesome. When the host controller is combined with a controller whose clock signal used for generating a synchronizing signal of the host controller is slower than the clock signal used for generating the control cycle signal of the controller, there arises a problem of a failure to perform control processing in synchronism with the synchronizing signal output from the host controller.

At the timing at which the synchronizing signal has been input, start-up of the control interrupt processing waits until completion of the synchronizing interrupt processing. Hence, the control cycle is not constant, and the controller also suffers a problem of deteriorated control accuracy.

Despite the maximum process time allowed for control processing being a control cycle, the maximum process time is determined by subtracting, from the control cycle, the process time required for synchronization interrupt processing which is executed during input of a synchronizing signal from the host controller. Hence, the controller also suffers a problem of failing to make full use of performance of a CPU.

The present invention has been conceived in light of the drawbacks set forth, and aims at providing a controller which can execute control processing synchronism with a synchronizing signal output from a host controller without taking into consideration a difference between a clock signal used for generating a synchronizing signal of the host controller and a clock signal used for generating a control cycle signal of a controller; and can enhance accuracy performance of control by rendering constant intervals between start-up of control interrupt process times; that is, a control cycle.

Moreover, the present invention also aims at providing a controller which can make full use of performance of a CPU by taking a maximum process time allowed for control processing as a control cycle, as well as providing a control method.

### DISCLOSURE OF THE INVENTION

To achieve the above objects, Present Invention 1 is characterized by a controller comprising means for generating a synchronization interrupt signal when a synchronizing signal output from the outside, such as a host controller, during a given cycle is input; means which generates a control cycle signal used for effecting control processing during a given cycle; means for generating a control interrupt signal when the control cycle signal is input; means which receives an input of data from the host controller and outputs data to the host controller; a synchronization interrupt processing section which performs synchronization interrupt processing when the synchronization interrupt signal is input; and a control interrupt processing section which performs control interrupt processing when the control interrupt signal is input, wherein

the synchronization interrupt processing section adjusts the means for generating a control cycle signal to thus generate the control interrupt signal such that the control cycle signal is generated while being delayed by an amount equal to or greater than the duration of an accuracy error between a quartz oscillator used for generating the synchronization interrupt signal and a quartz oscillator used for generating the control cycle signal, thereby executing control interrupt processing in synchronism with the synchronizing signal from the outside.

According to the controller of Present Invention 1, a control cycle generation circuit is adjusted by means of synchronization interrupt processing such that a control cycle signal is generated while being delayed by the amount corresponding to the duration of an accuracy error between two quartz oscillators. As a result, control processing can be performed in synchronism with a synchronizing signal input from the outside, such as a host controller, without taking into consideration a difference between the clock signal used for generating the synchronizing signal of the host controller and the clock signal used for generating the control cycle signal of the controller.

Present invention 2 is characterized in that the synchronization interrupt processing section adjusts the means for generating a control cycle signal to thus generate the control interrupt signal such that the control cycle signal is generated while being delayed by an amount equal to or greater than the duration of a maximum execution time of the synchronization interrupt processing section, thereby rendering constant a control interrupt processing cycle without regard to an execution time of the synchronization interrupt processing section or variations in an execution time.

According to the controller of Present Invention 2, the control cycle generation circuit is adjusted through synchronization interrupt processing such that a control cycle signal is generated after lapse of a maximum synchronization interrupt process time. As a result, the interval at which control interrupt processing starts; that is, a control cycle, can be made constant without being affected by a process time during which there is performed synchronization interrupt processing to be performed when the synchronization signal is input from the host controller. Consequently, the accuracy and performance of control can be enhanced.

Present invention 3 is characterized by a controller comprising means for generating a synchronization interrupt signal when a synchronizing signal output from the outside, such as a host controller, during a given cycle is input; means which generates a control cycle signal used for effecting control processing during a given cycle; means for generating a control interrupt signal when the control cycle signal is input; means which receives an input of data from the host controller and outputs data to the host controller; a synchronization interrupt processing section which performs synchronization interrupt processing when the synchronization interrupt signal is input; and a control interrupt processing section which performs control interrupt processing when the control interrupt signal is input, wherein

the synchronization interrupt processing section activates the means for generating a control cycle signal to thus generate the control interrupt signal, thereby executing control interrupt processing in synchronism with a synchronizing signal from the outside.

According to the controller of Present Invention 3, control processing can be performed in synchronism with a synchronizing signal output from the outside, such as from a host controller, without taking into consideration a difference between the clock signal used for generating the synchronizing signal of the host controller and the clock signal used for generating the control cycle signal of the controller. The maximum process time allowed for control processing becomes a control cycle, and the performance of the CPU can be fully exhibited.

Present Invention 4 is characterized in that the synchronization interrupt processing section executes process time adjustment processing, thereby rendering constant a process time required for synchronization interrupt processing.

According to the controller of Present Invention 4, when the synchronization interrupt processing involves conditional judgment, the process time required for synchronization interrupt processing can be made constant even when details of processing to be performed change depending on whether or not the condition stands. The control processing cycle can be maintained constant.

Present Invention 5 is characterized by a control method for use with a controller comprising means for generating a synchronization interrupt signal when a synchronizing signal output from the outside, such as from a host controller, during a given cycle is input; means which generates a control cycle signal used for effecting control processing during a given cycle; means for generating a control interrupt signal when the control cycle signal is input; means which receives an input of data from the host controller and outputs data to the host controller; a synchronization interrupt processing section which performs synchronization interrupt processing when the synchronization interrupt signal is input; and a control interrupt processing section which performs control interrupt processing when the control interrupt signal is input, the control method comprising:

inputting a synchronizing signal (S10) generated during a given cycle by the host controller to an interrupt circuit (21);

generating a synchronization interrupt signal (S20) by means of the interrupt circuit 21;

activating a control cycle generation circuit and causing the control cycle generation circuit to output a control cycle signal (S22) to the interrupt circuit (21);

generating a control interrupt signal (S21) and the synchronization interrupt signal (S20) by means of the interrupt circuit (21), and outputting the control interrupt signal and the synchronization interrupt signal to a CPU (20); and

activating a control cycle generation circuit, by means of software, which causes a synchronization interrupt processing section to start control interrupt processing.

Present Invention 6 is characterized in that the synchronization interrupt processing to be performed by the synchronization interrupt processing section comprises:

a step for processing input/output data (S11) (step 1);

a step for determining whether or not a condition stands (step 2);

a step for performing, when the condition stands, processing to be executed for a case where the condition stands (step 3);

a step of setting to 0 a process time adjustment value (step 30);

a step of performing, when the condition does not stand, processing to be executed for a case where the condition does not stand (step 4);

a step of setting, as the process time adjustment value, a value which is determined by subtracting the process time required for a case where the condition does not stand from the process time required for a case where the condition stands (step 40);

a step for causing processing to proceed to the next step when the process time adjustment value assumes 0 or for executing a dummy command corresponding to the process time adjustment value when the process time adjustment value assumes a value other than 0 (step 5); and

a step of activating a control cycle generation circuit (step 6).

Moreover, Present Invention 7 is intended for setting the process time adjustment value to 0 in the step (step 40) for setting a process time adjustment value when the process time for a case where the condition stands is shorter than a process time for a case where the condition does not stand or setting a value determined by subtracting the process time for a case where the condition stands from the process time for a case where the condition does not stand in the step (step 30) for setting to 0 the process time adjustment value.

According to the control methods of Present Inventions 5 to 7, the performance of the CPU can be fully exhibited by increasing the maximum process time allowed for control processing. By means of adjustment of the process time, even when changes occur in details of processing to be performed through synchronization interrupt processing which is performed upon input of a synchronizing signal from the higher-order apparatus, there is yielded an advantage of the ability to maintain the control processing cycle constant.

### BRIEF DESCRIPTION OF THE DRAWINGS

FIG. 1 is a block diagram showing the configuration of a controller according to a first embodiment of the present invention;

FIG. 2 is a descriptive view showing operation of software according to the first embodiment;

FIG. 3 is a timing chart showing operation of a controller according to a second embodiment of the present invention;

FIG. 4 is a block diagram showing the configuration of a controller according to a third embodiment of the present invention;

FIG. 5 is a descriptive drawing showing operation of software according to the third embodiment;

FIG. 6 is a timing chart showing operation of a controller according to a fourth embodiment of the present invention;

FIG. 7 is a flowchart showing operation procedures of the fourth embodiment;

FIG. 8 is a block diagram showing the configuration of a conventional controller; and

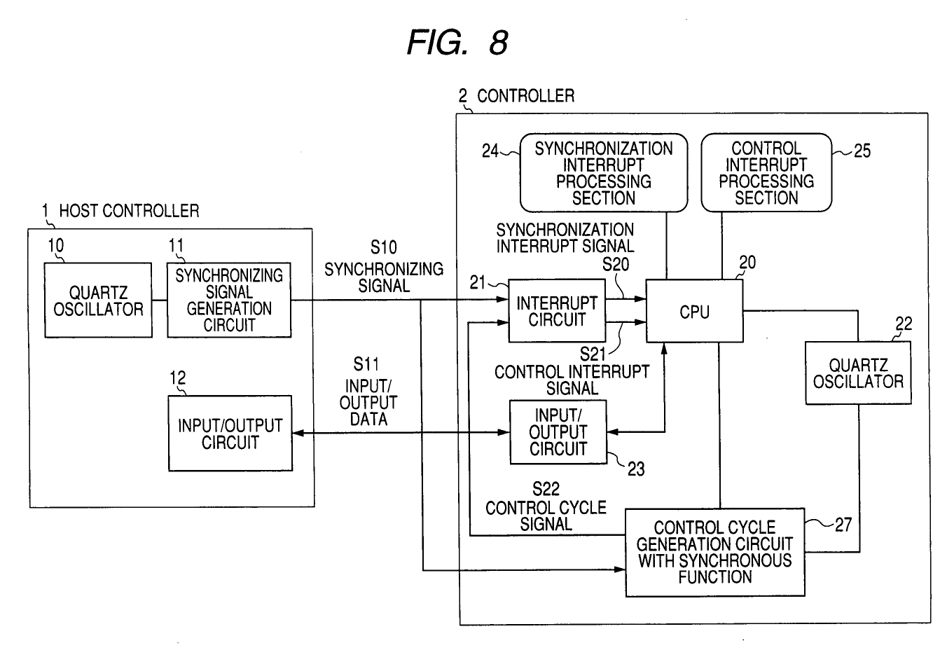

FIG. 9 is a timing chart for describing operation of the conventional controller.

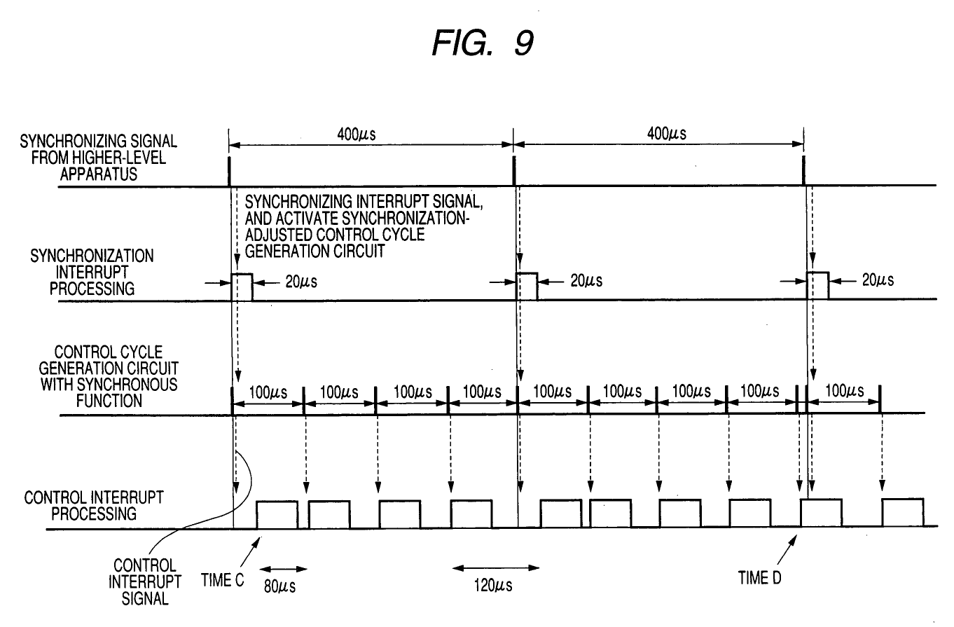

In the drawings, reference numeral 1 designates a host controller; 2 designates a controller; 10 designates a quartz oscillator; 11 designates a synchronizing signal generation circuit; 12 designates an input/output circuit; 20 designates a CPU; 21 designates an interrupt circuit; 22 designates a quartz oscillator; 23 designates an input/output circuit; 24 designates a synchronization interrupt processing section; 25 designates a control interrupt processing section; 26 designates a control cycle generation circuit; 27 designates a control cycle generation circuit with synchronous function; 28 designates a control cycle correction value; 29 designates a control cycle setting value; 100 designates a host controller; 110 designates a quartz oscillator; 111 designates a synchronizing signal generation circuit; 112 designates an input/output circuit; 200 designates a controller; 220 designates a CPU; 221 designates an interrupt circuit; 222 designates a quartz oscillator; 223 designates an input/output circuit; 224 designates a synchronization interrupt processing section; 225 designates a control interrupt processing section; 226 designates a control cycle generation circuit; 227 designates a synchronization-adjusted control cycle generation circuit; S10, S110 designate synchronizing signals; S11, S111 designate input/output data; S20, S220 designate synchronization interrupt signals; S21, S221 designate control interrupt signals; and S22, S222 designate control cycle signals.

### BEST MODE FOR IMPLEMENTING THE INVENTION

Embodiments of the present invention will now be described by reference to the drawings.

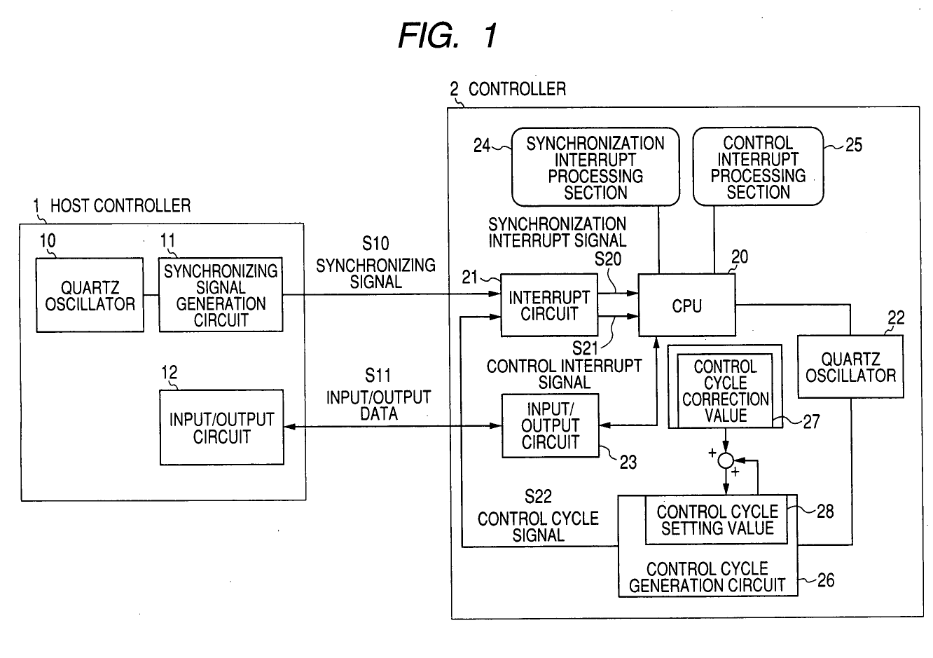

FIG. 1 is a block diagram showing the configuration of a controller according to a first embodiment of the present invention.

In FIG. 1, reference numeral 1 designates a host controller having the function of outputting a synchronizing signal to the outside, the function of outputting data to the outside, and the function of receiving an input of data from the outside. Reference numeral 10 designates a quartz oscillator which generates a clock signal. Reference numeral 11 designates a synchronizing signal generation circuit, which generates a signal during a predetermined cycle on the basis of a clock signal output from the quartz oscillator 10 and outputs the thus-generated signal to the outside. Reference numeral 12 designates an input/output circuit, which outputs data to the controller and receives an input of data from the controller. S10 designates a synchronizing signal, which is generated during a given cycle by the synchronizing signal generation circuit 11. Reference numeral S11 designates input/output data, which are exchanged with the controller by way of the input/output circuit 12.

Reference numeral 2 designates a controller, which is formed from a CPU, an interrupt circuit, an input/output circuit, and a control cycle generation circuit. Reference numeral 20 designates a CPU, which operates on a clock signal output from a quartz oscillator 22. Upon receipt of an input of a synchronization interrupt signal S20 from an interrupt circuit 21, the CPU 20 causes a synchronization interrupt processing section 25 to perform synchronization interrupt processing. Upon receipt of a control interrupt signal S21 from the interrupt circuit 21, the CPU 20 causes the control interrupt processing section 24 to perform control interrupt processing. Reference numeral 21 designates the interrupt circuit, which generates the synchronization interrupt signal S20 upon receipt of an input of the synchronizing signal S10 from the host controller 1 and outputs the thus-generated signal to the CPU 20. Upon receipt of an input of the control cycle signal S22 from a control cycle generation circuit 26, the controller generates the control interrupt signal S21 and outputs the thus-generated signal to the CPU 20. Reference numeral 22 designates the quartz oscillator, which generates a clock signal. Reference numeral 23 designates an input/output circuit, which outputs data to the host controller 1 and receives an input of data from the host controller 1. Reference numeral 24 designates the synchronization interrupt processing section, which processes the input/output data S11 and computes a control cycle correction value 27, to thus adjust a control cycle correction value 28. Reference numeral 25 designates a control interrupt processing section, which performs control processing such as position control, speed control, and torque control. Reference numeral 26 designates a control cycle generation circuit, which starts by the control cycle setting value 28 adjusted by the synchronization interrupt processing section and which generates a signal during a predetermined cycle on the basis of the clock signal output from the quartz oscillator 22 from a point in time when the control cycle generation circuit starts up. Specifically, when started by the synchronization interrupt processing section 24, the control cycle generation circuit 26 outputs the control cycle signal S22 simultaneous with starting measurement of the clock signal output from the quartz oscillator 22. When the cycle has reached a preset cycle, the control cycle signal S22 is output, whereby measurement of the clock signal output from the quartz oscillator 22 is initiated. Through repetition of these operations, a signal is generated during a given cycle. Reference numeral S20 designates the synchronization interrupt signal, which is generated by the interrupt circuit 21 when the synchronizing signal S10 is input from the host controller 1. Reference numeral S21 designates the control interrupt signal, which is generated by the interrupt circuit 21 when the control cycle signal S22 is input from the control cycle generation circuit 26. S22 designates a control cycle signal, which is generated by the control cycle generation circuit 26.

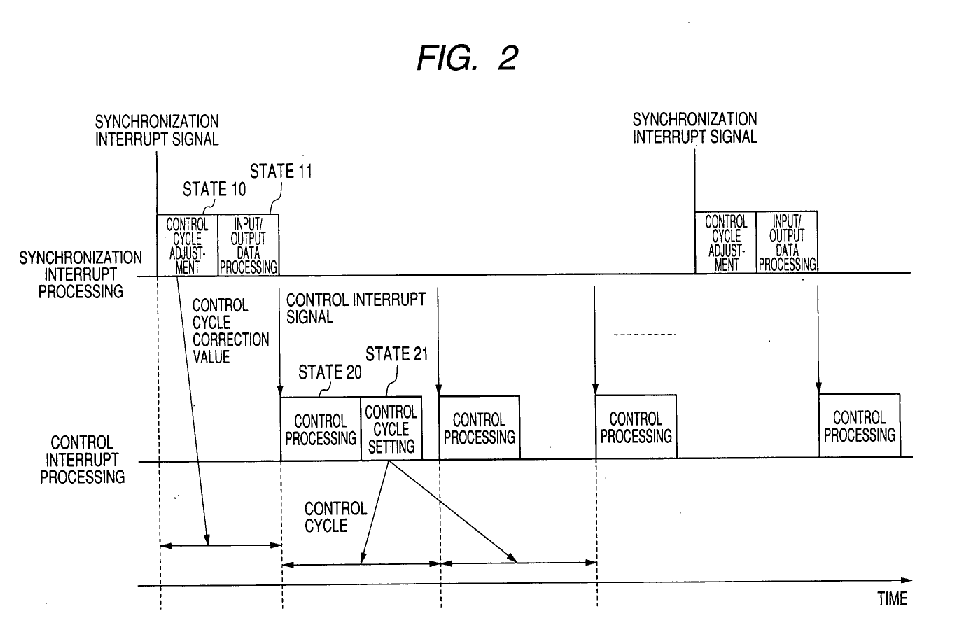

FIG. 2 is a view which describes operation of software performed when the synchronizing signal S10 is input during a given cycle by the host controller 1.

In FIG. 2, when the synchronizing signal S10 generated during a given cycle by the host controller 1 is input, the interrupt circuit 21 shown in FIG. 1 generates the synchronization interrupt signal S20, and the CPU 20 causes the synchronization interrupt processing section 24 to execute synchronization interrupt processing.

In the synchronization interrupt processing executed by the synchronization interrupt processing section 24, the control cycle-adjusted value 27 is computed from a clock measurement value output from the control cycle generation circuit 26 such that the control cycle signal S22 is generated after lapse of a time equal to or longer than the duration of an accuracy error existing between the quartz oscillator 10 and the quartz oscillator 22, and the control cycle setting value 28 is adjusted (State 10 in FIG. 2).

The input/output data S11 are now processed (State 11 in FIG. 2).

The input/output data is comprised of command data input by the controller 2 and feedback data output by the controller 2. The command data is comprised of a position command, a speed command, and a torque command. The feedback data is comprised of a current position, a current speed, or the like. When the control cycle generation circuit 26 adjusted through synchronization interrupt processing starts up, the control cycle generation circuit 26 outputs the control cycle signal S22; the interrupt circuit 21 generates the control interrupt signal S21; and the CPU 20 causes the control interrupt processing section 24 to perform control interrupt processing. The control interrupt processing section 25 performs control processing, such as position control, speed control, torque control, or the like (State 20 in FIG. 2). During the control interrupt processing performed immediately after the control cycle setting value has been adjusted through synchronization interrupt processing, a setting value of fixed cycle is set in the control cycle setting value 28 (State 21 in FIG. 2).

As mentioned above, the synchronization interrupt processing section 24—which is caused to operate when the synchronizing signal S10 generated during a given cycle by the host controller 1 is input—adjusts the control cycle generation circuit 26 which starts control interrupt processing, by means of software, such that a control cycle signal is generated after lapse of a period of time corresponding to the duration of an accuracy error between two quartz oscillators. Even when the clock signal used for generating the synchronizing signal S10 of the host controller 1 is slower than the clock signal used for generating the control cycle signal S22 of the controller 2, control processing can be performed in synchronism with the synchronizing signal S10 output from the host controller 1.

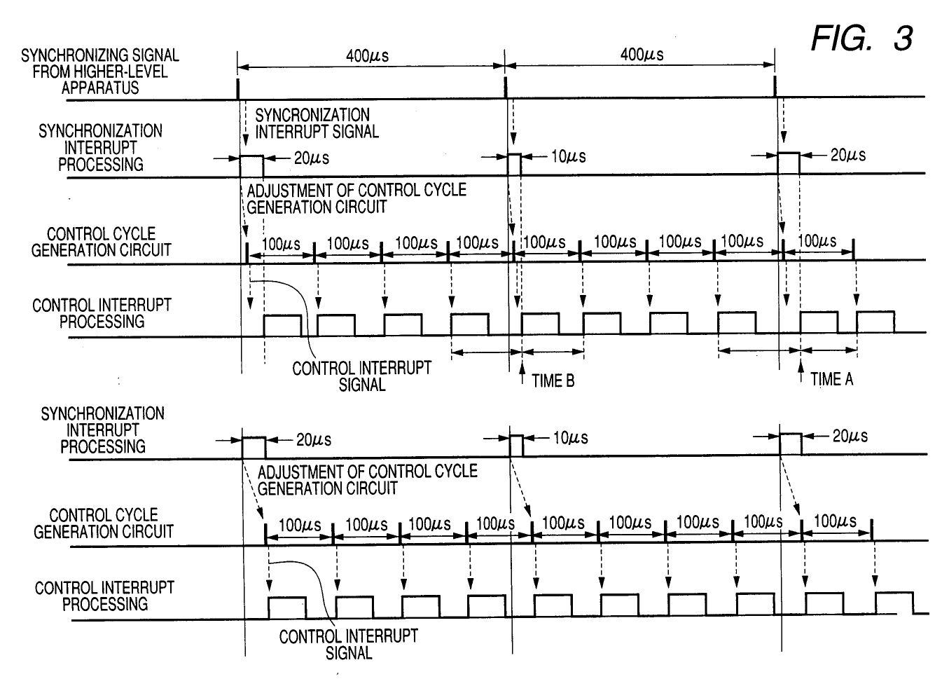

A second embodiment of the present invention will now be described by reference to FIG. 3.

A block diagram showing the configuration of the second embodiment is identical with that shown in FIG. 1. Moreover, a view showing operation of software is identical with that shown in FIG. 2. A difference between the first and second embodiments lies in a time required to adjust the control cycle generation circuit.

FIG. 3 is a timing chart showing operation of the controller according to the second embodiment of the present invention.

In FIG. 3, when the synchronizing signal S10 generated during a predetermined cycle by the host controller 1 (shown in FIG. 1) is input, the interrupt circuit 21 generates the synchronization interrupt signal S20, and the CPU 20 activates the synchronization interrupt processing section 24, whereby synchronization interrupt processing is performed. In general, when synchronization interrupt processing does not involve conditional judgment, the time required for synchronization interrupt processing is constant. However, when synchronization interrupt processing involves conditional judgment, the time required for synchronization interrupt processing changes depending on whether or not the condition stands. In the case of the first embodiment, the control cycle correction value 27 is computed through the synchronization interrupt processing such that the control cycle signal S22 is generated at the time of commencement of synchronization interrupt processing and after lapse of a time equal to the duration of an accuracy error between the two quartz oscillators. The control cycle setting value 28 of the control cycle generation circuit 26 is adjusted, and the control cycle generation circuit 26 starts up at the timing of the adjusted control cycle setting value. The interrupt circuit 21 generates the control interrupt signal from the control cycle signal S22. The synchronization interrupt processing is higher in priority level than the control interrupt processing. Therefore, the CPU 20 causes the control interrupt processing section 25 to operate after completion of synchronization interrupt processing. In this embodiment, the synchronizing signal S10 output from the host controller and the synchronization interrupt signal S20 are generated at an interval of 400 μs, and the control interrupt signal S21 is generated at an interval of 100 μs.

However, even when the synchronization interrupt processing is made constant at an interval of 20 μs and the control interrupt signal is generated, control interrupt processing is executed after lapse of a synchronization interrupt process time of 20 μs, and hence the control cycles achieved before and after generation of the synchronization interrupt signal assume a value of about 120 μs and a value of about 80 μs, as in the case of time A. On condition that the synchronization interrupt processing performed by the synchronization interrupt processing section is not constant and that the control cycle assumes a period of 20 μs when condition stands or a period of 10 μs when condition does not stand, the control cycles achieved before and after generation of the synchronization interrupt signal assume a period of about 110 μs and a period of about 90 μs, as in the case of time B. Further, variations arise in a control cycle, and the control processing cycle during which control interrupt processing is performed is changed, thereby generally deteriorating control accuracy.

The control processing cycle must be subjected to correction processing by means of time management in order to achieve high accuracy.

Now, during synchronization interrupt processing, the control cycle generation circuit 26 computes the control cycle correction value 27 and adjusts the control cycle setting value 28 such that the control cycle signal S22 is generated after lapse of a maximum value achieved during execution of synchronization interrupt processing; that is, 20 μs, the synchronization interrupt processing to be started by the synchronizing signal output from the host controller is executed when the condition stands, as in the case of time A, and the control interrupt signal is generated by way of the control cycle generation circuit immediately after synchronization interrupt processing, so that control interrupt processing is executed.

As in the case of time B, when synchronization interrupt processing is executed for the case where the condition does not stand, a control interrupt signal is generated by way of the control cycle generation circuit after lapse of 10 μs after completion of synchronization interrupt processing, whereupon control interrupt processing is performed. Specifically, regardless of whether or not conditions for determining synchronization interrupt processing stand, a control cycle signal is generated after lapse of 20 μs and a given period of time after commencement of synchronization interrupt processing. Consequently, the control cycle during which control interrupt processing is performed assumes a period of 100 μs and becomes constant.

As mentioned previously, through synchronous interrupt processing, adjustment is performed such that the control cycle signal is generated by the control cycle generation circuit after lapse of the maximum time required for synchronization interrupt processing after commencement of synchronization interrupt processing. As a result, the control interrupt processing is performed without waiting by synchronization interrupt processing. Moreover, when the synchronization interrupt processing involves conditional judgment, control interrupt processing is performed immediately after lapse of a given time following commencement of synchronization interrupt processing and as a result of generation of the control cycle signal after completion of the synchronization interrupt processing, without regard to whether or not the conditional judgment of the synchronization interrupt processing stands. Therefore, a control processing cycle at which control interrupt processing is performed can be maintained constant.

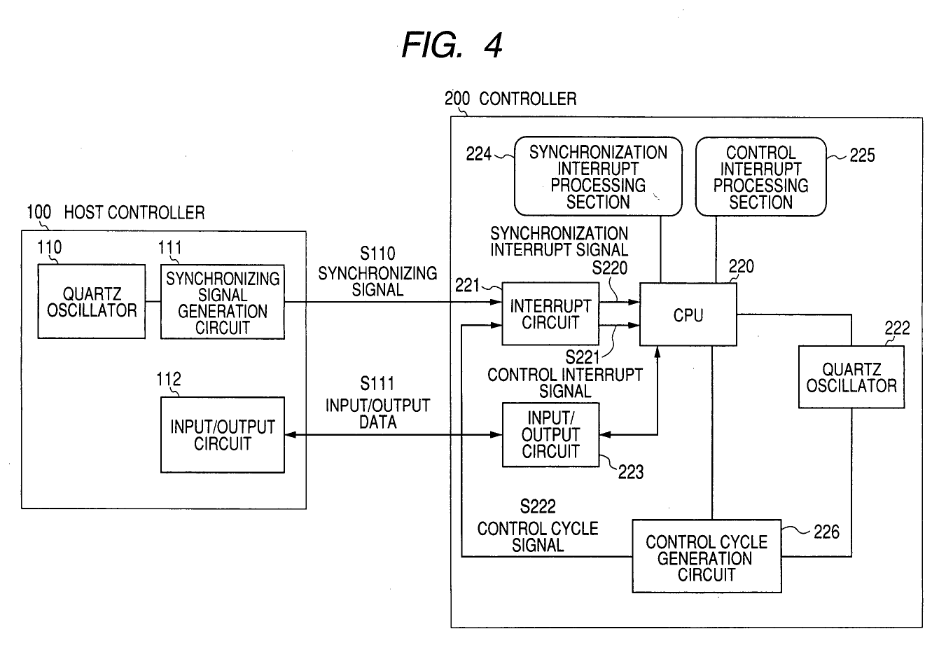

FIG. 4 is a block diagram showing the configuration of a controller according to a third embodiment of the present invention.

In FIG. 4, reference numeral 100 designates a host controller having the function of outputting a synchronizing signal to the outside, the function of outputting data to the outside, and the function of receiving an input of data from the outside.

Reference numeral 110 designates a quartz oscillator which generates a clock signal. Reference numeral 111 designates a synchronizing signal generation circuit, which generates a signal during a predetermined cycle on the basis of a clock signal output from the quartz oscillator 110 and outputs the thus-generated signal to the outside. Reference numeral 112 designates an input/output circuit, which outputs data to the controller and receives an input of data from the controller. S110 designates a synchronizing signal, which is generated during a given cycle by the synchronizing signal generation circuit 111. Reference numeral S111 designates input/output data, which are exchanged with the controller by way of the input/output circuit 112.

Reference numeral 200 designates a controller, which is formed from a CPU, an interrupt circuit, an input/output circuit, and a control cycle generation circuit. Reference numeral 220 designates a CPU, which operates on a clock signal output from the quartz oscillator. Upon receipt of an input of a synchronization interrupt signal S220 from an interrupt circuit 221, the CPU performs synchronization interrupt processing. Upon receipt of the control interrupt signal S221 from the interrupt circuit 221, the CPU performs control interrupt processing. Reference numeral 221 designates the interrupt circuit, which generates the synchronization interrupt signal S220 upon receipt of an input of the synchronizing signal S110 from the host controller and outputs the thus-generated signal to the CPU 220. Upon receipt of a signal from a control cycle generation circuit 226, the controller generates the control interrupt signal S221 and outputs the thus-generated signal to the CPU 220. Reference numeral 222 designates the quartz oscillator, which generates a clock signal. Reference numeral 223 designates an input/output circuit, which outputs data to the host controller 100 and receives an input of data from the host controller 100. Reference numeral 224 designates a synchronization interrupt processing section, which processes the input/output data S111, thereby starting up the control cycle generation circuit 226. Reference numeral 225 designates a control interrupt processing section, which performs control processing such as position control, speed control, and torque control. Reference numeral 226 designates the control cycle generation circuit, which starts by the synchronization interrupt processing section and which generates a signal during a predetermined cycle on the basis of the clock signal output from the quartz oscillator 222 from a point in time when the control cycle generation circuit starts up. Specifically, when started by the synchronization interrupt processing section, the control cycle generation circuit outputs the control cycle signal simultaneous with starting measurement of the clock signal output from the quartz oscillator 222. When the cycle has reached a preset cycle, the control cycle signal is output, whereby measurement of the clock signal output from the quartz oscillator 222 is initiated. Through repetition of these operations, a signal is generated during a given cycle. Reference numeral S220 designates the synchronization interrupt signal, which is generated by the interrupt circuit 221 when the synchronizing signal S210 is input from the host controller. Reference numeral S221 designates the control interrupt signal, which is generated by the interrupt circuit 221 when the control cycle signal is input from the control cycle generation circuit 226. S222 designates a control cycle signal, which is generated by the control cycle generation circuit 226.

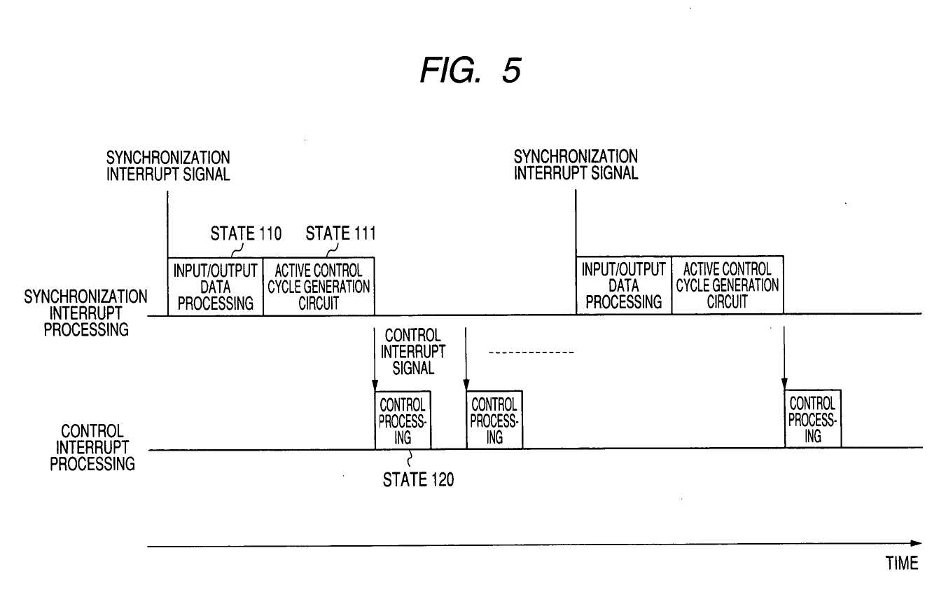

FIG. 5 is a view which describes operation of software performed when the synchronizing signal S110 generated during a given cycle by the host controller 100 (FIG. 4) is input. In FIG. 5, when the synchronizing signal S110 generated during a given cycle by the host controller 100 is input, the interrupt circuit 221 generates the synchronization interrupt signal S220, and the CPU 220 causes the synchronization interrupt processing section 224 to execute synchronization interrupt processing. In the synchronization interrupt processing executed by the synchronization interrupt processing section 224, the input/output data S111 are processed (State 110). The input/output data is comprised of command data input by the controller 200 and feedback data output by the controller 200. The command data is comprised of a position command, a speed command, a torque command, and the like. The feedback data is comprised of a current position, a current speed, or the like.

Next, the control cycle generation circuit 226 (FIG. 4) starts up (State 111).

When started up, the control cycle generation circuit 226 outputs the control cycle signal S222; the interrupt circuit 221 generates the control interrupt signal S221; and the CPU 220 causes the control interrupt processing section 225 to perform control interrupt processing. The control interrupt processing section 225 performs control processing, such as position control, speed control, torque control, or the like (State 120).

As mentioned above, by means of synchronization interrupt processing—which is performed when the synchronizing signal S110 generated during a given cycle by the host controller 100 is input—the control cycle generation circuit which starts up control interrupt processing starts by software. As a result, even when the clock signal used for generating the synchronizing signal of the host controller is slower than the clock signal used for generating the control cycle signal of the controller, control processing can be performed in synchronism with the synchronizing signal output from the host controller.

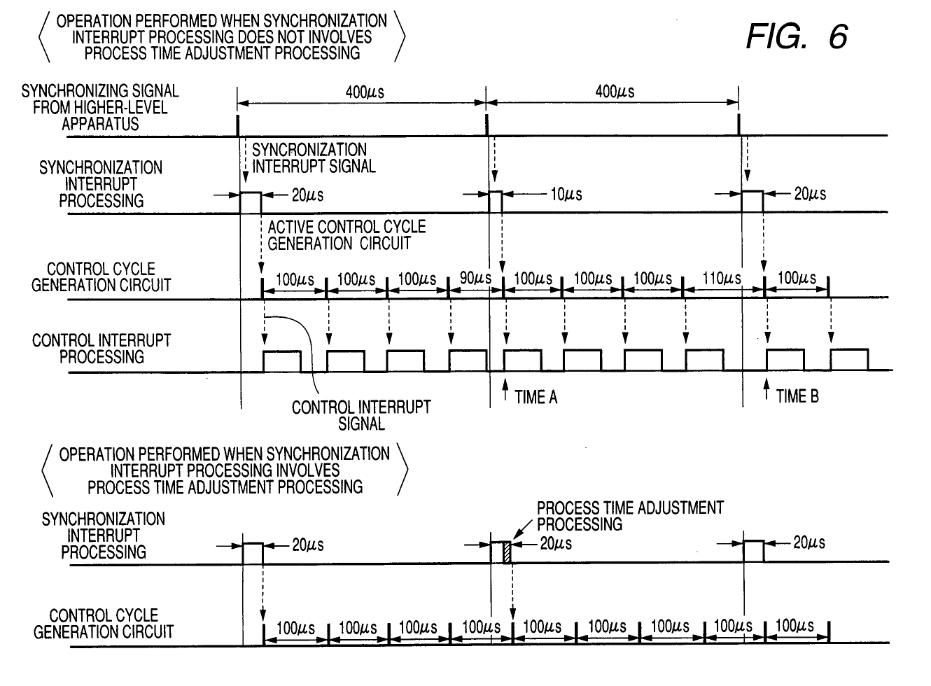

A fourth embodiment of the present invention will now be described by reference to FIG. 6.

A block diagram showing the configuration of the fourth embodiment is identical with that shown in FIG. 4. A difference between the third and fourth embodiments lies in operation of software.

FIG. 6 is a timing chart showing operation of the controller according to the fourth embodiment of the present invention.

In FIG. 6, when the synchronizing signal S110 generated in a predetermined cycle by the host controller 100 (shown in FIG. 4) is input, the interrupt circuit 221 generates the synchronization interrupt signal S220, and the CPU 220 activates the synchronization interrupt processing section, whereby synchronization interrupt processing is performed. In general, when synchronization interrupt processing does not involve conditional judgment, the time required for synchronization interrupt processing is constant. However, when synchronization interrupt processing involves conditional judgment, the time required for synchronization interrupt processing changes depending on whether or not the condition stands. The control cycle generation circuit starts by the synchronization interrupt processing, and the interrupt circuit 221 generates a control interrupt signal by means of the control cycle signal S222, whereby the CPU 220 causes the control interrupt processing section to operate. In this embodiment, the synchronizing signal S110, which is output from the host controller, and the synchronization interrupt signal S220 are generated at intervals of 400 μs, and the control interrupt signal S221 is generated at intervals of 100 μs. The synchronization interrupt processing performed by the synchronization interrupt processing section is not constant and is performed at an interval of 20 μs when the condition stands but at an interval of 10 μs when the condition does not stand.

As in the case of time A shown in FIG. 6, when synchronization interrupt processing to be executed by a synchronizing signal from the host controller does not stand, the cycle of the control interrupt signal generated by way of the control cycle generation circuit assumes a value of 90 μs.

As in the case of time B shown in FIG. 6, when synchronization interrupt processing is executed for the case where the condition stands, the cycle of the control interrupt signal generated by way of the control cycle generation circuit assumes a value of 110 μs.

As mentioned previously, when the synchronization interrupt processing involves conditional judgment, the time required for synchronization interrupt processing changes depending on whether or not conditional judgment stands. Since the control processing cycle at which control interrupt processing is performed changes, control accuracy is generally deteriorated. Therefore, when the synchronization interrupt processing involves conditional judgment, process time adjustment processing is performed before start-up of the control cycle generation circuit, thereby rendering constant the time required for synchronization interrupt processing without regard to whether or not conditional judgment of the synchronization interrupt processing stands.

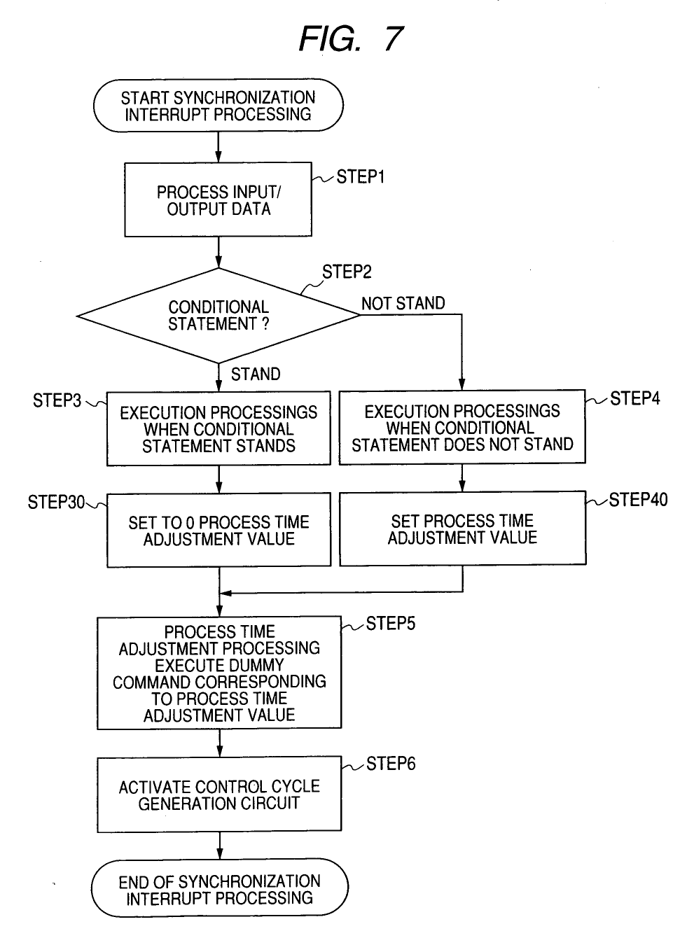

FIG. 7 is a flowchart which describes operation procedures required when the synchronization interrupt processing involves conditional judgment. FIG. 7 differs from the drawing pertaining to the third embodiment in steps 2 to 5.

In FIG. 7, synchronization interrupt processing performed by the synchronization interrupt processing section first comprises processing of the input/output data S111 (step 1).

Next, processing for determining whether or not conditional statement stands or not (step 2).

When the conditional statement is true, processing is executed along the condition of true (step 3).

A process time adjustment value is set to 0 (step 30).

When the conditional statement does not stand, processing is executed along the condition of false (step 4).

A value determined by subtracting the process time required when condition does not stand from the process time required when condition stands is set as the process time adjustment value (step 40).

Next, the process time adjustment processing is performed (step 5). Specifically, when the process time adjustment value assumes 0, processing proceeds to the next step. When the process time adjustment value assumes a value other than 0, a dummy command corresponding to the process time adjustment value is executed.

Finally, the control cycle generation circuit starts (step 6).

The embodiment is based on the assumption that the process time required when the condition stands is longer than the process time required when the condition does not stand. Conversely, when the process time required when the condition stands is shorter than the process time required when the condition does not stand, the essential requirement is to set 0 for the process time adjustment value in step 40, and to set in step 30 a value determined by subtracting the process time required when condition stands from the process time required when condition does not stand.

As mentioned above, when the synchronization interrupt processing involves conditional judgment, process time adjustment processing is performed before start-up of the control cycle generation circuit. As a result, the process time required for synchronization interrupt processing can be maintained constant without regard to whether or not conditional judgment of the synchronization interrupt processing stands. Consequently, a control processing cycle at which control interrupt processing is performed can be maintained constant.

As has been described above, according to the controller of the present invention, a control cycle generation circuit is adjusted by means of synchronization interrupt processing such that a control cycle signal is generated while being delayed by the amount corresponding to the duration of an accuracy error between two quartz oscillators. As a result, control processing can be performed in synchronism with a synchronizing signal input from the outside, such as a host controller, without taking into consideration a difference between the clock signal used for generating the synchronizing signal of the host controller and the clock signal used for generating the control cycle signal of the controller. Moreover, the control cycle generation circuit is adjusted through synchronization interrupt processing such that a control cycle signal is generated after lapse of a maximum synchronization process time. As a result, the interval at which control interrupt processing starts; that is, a control cycle, can be made constant without being affected by a process time during which there is performed synchronization interrupt processing to be performed when the synchronization signal is input from the host controller. Consequently, the accuracy and performance of control can be enhanced.

Control processing can be performed in synchronism with a synchronizing signal output from the outside, such as from a host controller, without taking into consideration a difference between the clock signal used for generating the synchronizing signal of the host controller and the clock signal used for generating the control cycle signal of the controller. The maximum process time allowed for control processing becomes a control cycle, and the performance of the CPU can be fully exhibited. When the synchronization interrupt processing involves conditional judgment, the process time required for synchronization interrupt processing can be made constant even when details of processing to be performed change depending on whether or not the condition stands. The control processing cycle can be maintained constant.

According to the control method of the present invention, the performance of the CPU can be fully exhibited by increasing the maximum process time allowed for control processing. By means of adjustment of the process time, even when changes occur in details of processing to be performed through synchronization interrupt processing which is performed when a synchronizing signal from the host controller is input, there is yielded an advantage of the ability to maintain the control processing cycle constant.

1. An externally-synchronizable controller comprising means for generating a synchronization interrupt signal when a synchronizing signal output from the outside, such as from a host controller, is input during a given cycle; means which generates a control cycle signal used for effecting control processing during a given cycle; means for generating a control interrupt signal when said control cycle signal is input; means which receives an input of data from said host controller and outputs data to said host controller; a synchronization interrupt processing section which performs synchronization interrupt processing when said synchronization interrupt signal is input; and a control interrupt processing section which performs control interrupt processing when said control interrupt signal is input, wherein
said synchronization interrupt processing section adjusts said means for generating a control cycle signal to thus generate said control interrupt signal such that said control cycle signal is generated while being delayed by an amount equal to or greater than the duration of an accuracy error between a quartz oscillator used for generating said synchronization interrupt signal and a quartz oscillator used for generating said control cycle signal, thereby executing control interrupt processing in synchronism with said synchronizing signal from the outside.

2. The externally-synchronizable controller according to claim 1, wherein said synchronization interrupt processing section adjusts said means for generating a control cycle signal to thus generate said control interrupt signal such that said control cycle signal is generated while being delayed by an amount equal to or greater than the duration of a maximum execution time of said synchronization interrupt processing section, thereby rendering constant a control interrupt processing cycle without regard to an execution time of said synchronization interrupt processing section or variations in an execution time.

3. An externally-synchronizable controller comprising means for generating a synchronization interrupt signal when a synchronizing signal output from the outside, such as from a host controller, is input during a given cycle; means which generates a control cycle signal used for effecting control processing during a given cycle; means for generating a control interrupt signal when said control cycle signal is input; means which receives an input of data from said host controller and outputs data to said host controller; a synchronization interrupt processing section which performs synchronization interrupt processing when said synchronization interrupt signal is input; and a control interrupt processing section which performs control interrupt processing when said control interrupt signal is input, wherein
said synchronization interrupt processing section activates said means for generating a control cycle signal to thus generate said control interrupt signal, thereby executing control interrupt processing in synchronism with a synchronizing signal from the outside.

4. The externally-synchronizable controller according to claim 3, wherein said synchronization interrupt processing section executes process time adjustment processing, thereby rendering constant a process time required for synchronization interrupt processing.

5. An externally-synchronizable control method for use with a controller comprising means for generating a synchronization interrupt signal when a synchronizing signal output from the outside, such as from a host controller, is input during a given cycle; means which generates a control cycle signal used for effecting control processing during a given cycle; means for generating a control interrupt signal when said control cycle signal is input; means which receives an input of data from said host controller and outputs data to said host controller; a synchronization interrupt processing section which performs synchronization interrupt processing when said synchronization interrupt signal is input; and a control interrupt processing section which performs control interrupt processing when said control interrupt signal is input, said control method comprising:
inputting to an interrupt circuit (21) a synchronizing signal (S10) generated during a given cycle by said host controller;
generating a synchronization interrupt signal (S20) by means of said interrupt circuit 21;
activating a control cycle generation circuit and causing said control cycle generation circuit to output a control cycle signal (S22) to said interrupt circuit (21);
generating a control interrupt signal (S21) and said synchronization interrupt signal (S20) by means of said interrupt circuit (21), and outputting said control interrupt signal and said synchronization interrupt signal to a CPU (20); and
activating a control cycle generation circuit, by means of software, which causes a synchronization interrupt processing section to start control interrupt processing.

6. The externally-synchronizable control method according to claim 5, wherein said synchronization interrupt processing to be performed by said synchronization interrupt processing section comprises:
a step for processing input/output data (S11) (step 1);
a step for determining whether or not a condition stands (step 2);
a step for performing, when said condition stands, processing to be executed for a case where said condition stands (step 3);
a step of setting to 0 a process time adjustment value (step 30);
a step of performing, when said condition does not stand, processing to be executed for a case where said condition does not stand (step 4);
a step of setting, as said process time adjustment value, a value which is determined by subtracting said process time required for a case where said condition does not stand from said process time required for a case where said condition stands (step 40);
a step for causing step to proceed to the next step when said process time adjustment value assumes 0 or executing a dummy command corresponding to said process time adjustment value when said process time adjustment value assumes a value other than 0 (step 5); and
a step of activating a control cycle generation circuit (step 6).

7. The externally-synchronizable control method according to claim 6, wherein said process time adjustment value is set to 0 in said step (step 40) for setting a process time adjustment value when said process time for a case where said condition stands is shorter than a process time for a case where said condition does not stand, or to a value determined by subtracting said process time for a case where said condition stands from said process time for a case where said condition does not stand in said step (step 30) for setting to 0 said process time adjustment value.
